(19) United States
(12) Patent Application Publication
(10) Pub. No.: US 2026/0361025 A1
(43) Pub. Date: Nov. 12, 2026

(54) HIGH CURRENT ELECTRICAL CONNECTOR WITH IMPROVED SERVICEABILITY

(71) Applicant: Amphenol Corporation, Wallingford, CT (US)

(72) Inventors: Yilin Liu, Dongguan (CN); Yulin Rao, Dongguan City (CN)

(73) Assignee: Amphenol Corporation, Wallingford, CT (US)

(21) Appl. No.: 19/718,786

(22) Filed: Jun. 24, 2026

Related U.S. Application Data
(63) Continuation of application No. PCT/CN2024/116774, filed on Sep. 4, 2024.
Application No. PCT/CN2024/116774 is a continuation-in-part of application No. 29/923,337, filed on Dec. 28, 2023, now Pat. No. D1128595.
Application No. 29/923,337 is a continuation-in-part of application No. 29/923,345, filed on Dec. 28, 2023, now Pat. No. D1095437.
Application No. 29/923,345 is a continuation-in-part of application No. 29/923,369, filed on Dec. 28, 2023, now Pat. No. D1130321.
Application No. 29/923,369 is a continuation-in-part of application No. 29/923,334, filed on Dec. 28, 2023, now Pat. No. D1095436.

(51) Int. Cl. H01R 13/53; H01R 13/52; H01R 13/627; H01R 43/20

(52) U.S. Cl. CPC H01R 13/53; H01R 13/5219; H01R 13/6275; H01R 43/20

(57) ABSTRACT

An electrical connection system with high current carrying capacity that can be simply assembled or disassembled for repair. Such connection systems may be used in applications with a high risk of damage to a connector, such as in vehicle charging cords. The plug and/or receptacle connectors may include features that enable power and/or signal terminals to be easily installed or removed from the connector housings, such that the housing or the terminals can be easily and quickly replaced, even in the field, if damaged. Such features may include a clip captured between a terminal and a housing with compliant portions that engage the housing and the terminal. A compliant portion of the clip may be aligned with an opening in the connector housing through which the terminal is inserted such that insertion of a tool through that opening enables the terminal to be disengaged for removal.

### BACKGROUND

High current electrical connectors are becoming more common due to increased electrification. These connectors are commonly used in applications including making connections to electric vehicles for charging their batteries, connecting multiple batteries in energy storage facilities, and other applications requiring high current. High current connectors, sometimes called power connectors, may be damaged as they are used in these applications. Such damage can be costly because of the cost to repair or replace the connector as well as because of the loss of use of the equipment to which electrical connections are inhibited while the high current electrical connectors are being repaired or replaced.

### BRIEF SUMMARY

Concepts as disclosed herein may be embodied as an electrical connector configured to support a high current. The electrical connector may comprise an electrically conductive terminal, configured to support a current of at least 160A. The electrically conductive terminal may comprise a mating portion and a cable termination portion, and the mating portion may comprise an integral, generally planar metal member. The electrical connector may also comprise a cable terminated to the cable termination portion of the terminal; and an insulative housing. The insulative housing may comprise a cavity; a first portion elongated in a first direction and comprising a first surface with a first opening into the cavity therethrough, the first opening sized for the electrically conductive terminal to pass through the first opening into the cavity; a second portion comprising a second surface with a second opening into the cavity therethrough; and at least one member elongated in the first direction spanning the second opening. The mating portion of the electrically conductive terminal may be disposed within the cavity and accessible through the second opening. The first surface and the second surface may be at right angles, and the cable terminated to the cable termination portion of the terminal may extend through the first opening. The electrical connector may further comprise a cap secured to the housing so as to cover the first opening and having the cable passing therethrough; a metal clip, within the cavity, engaging a retaining notch of the electrically conductive terminal such that the electrically conductive terminal is retained within the cavity; and a latch pivotably coupled to the second portion of the housing.

Alternatively or additionally, concepts as disclosed herein may be embodied as a method of manufacturing an electrical connector configured to support a current of at least 160A. The method may comprise . . . placing a clip within a cavity of an insulative housing and moving a mating portion of an electrically conductive terminal in a first direction into a cavity of an insulative housing through a first opening in the housing. The mating portion may engage the insulative housing such that the clip may be compressed between the electrically conductive terminal and the insulative housing. The method of manufacturing an electrical connector may also include engaging the clip to the insulative housing and the electrically conductive terminal to the clip such that motion of the electrically conductive terminal in a direction opposite the first direction may be restrained.

Alternatively or additionally, concepts as disclosed herein may be embodied as an electrical connector system configured to support a current of at least 160A. The electrical connector system may comprise a plug connector. The plug connector may comprise a plug housing comprising a cavity; a clip within the cavity; and a plug terminal held within the cavity by the clip. The electrical connector system may also comprise a receptacle connector. The receptacle connector may comprise a receptacle housing comprising a cavity and an exterior surface with a plurality of protrusions on; and a receptacle terminal comprising a mating portion and a cable termination portion. The mating portion may comprise a plurality of spring fingers. The receptable connector may also comprise a retention member engaged to the exterior of the receptacle housing via a snap fit with the plurality of protrusions. The retention member may comprise an opening with the cable termination portion of the receptacle terminal extending through the opening.

These techniques may be used alone or in any suitable combination. The foregoing summary is provided by way of illustration and is not intended to be limiting.

### BRIEF DESCRIPTION OF DRAWINGS

Various aspects of at least one embodiment are discussed herein with reference to the accompanying figures. The figures are included to provide illustration and a further understanding of the various aspects and embodiments and are incorporated in and constitute a part of this specification but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence is intended to have any limiting effect on the scope of any claim element. In the figures, each identical or nearly identical component that is illustrated in various figures is represented by a like numeral. For purposes of clarity, not every component may be labeled in every figure. In the figures:

FIG. 1 is a perspective view of an example high current electrical connection system with mated receptacle and plug connectors, according to some embodiments of the technology described herein.

FIG. 2A is a front perspective view of the example receptacle connector of the high current electrical connection system of FIG. 1, showing the mating interface of the receptacle connector.

FIG. 2B is a perspective view of the example receptacle connector of FIG. 2A with a front housing portion cut away to reveal a terminal subassembly inside the housing.

FIG. 2C is a perspective view of the terminal subassembly of the example receptacle connector of FIG. 2A.

FIG. 3A is a front perspective view of the example plug connector of the high current electrical connection system of FIG. 1 showing the mating interface of the plug connector.

FIG. 3B is an example of internal components of the plug connector of FIG. 3A.

FIG. 4A is an enlarged perspective view of portions latch of the high current electrical connection system of FIG. 1 with mated receptacle and plug.

FIG. 4B is a perspective view of the high current electrical connection system of FIG. 1 with the receptacle and plug connectors separated, such as may occur during a mating or unmating process.

FIG. 5A is a sectional view of a plug connector of the high current electrical connection system of FIG. 1.

FIG. 5B is a perspective view of a retaining member of the high current electrical connection system of FIG. 1.

FIG. 5C is a perspective view of a terminal assembly and a housing of a plug connector of the high current electrical connection system of FIG. 1, separated such as may occur during an assembly process of the plug connector.

FIG. 6 is a perspective view of a terminal assembly, housing and cap of a receptacle connector of the high current electrical connection system of FIG. 1, separated such as may occur during an assembly process of the receptacle connector.

### DETAILED DESCRIPTION

The inventors have recognized and appreciated designs that increase serviceability and simplify handling of high current electrical connectors. These techniques may be used alone or in combination in any of multiple connector configurations to support applications where serviceability and/or simplified connector handling is advantageous.

Increased serviceability allows connectors to be maintained without requiring complete replacement of damaged connectors. Techniques as described herein may enable servicing of connectors and may be simple enough that the connectors can be maintained in the field. Increased serviceability reduces costs and system downtime, particularly for connectors used in environments in which there is a high incidence of damage. Connectors at the ends of charging cables for vehicles, for example, are frequently damaged because, when disconnected from a vehicle, they might be run over by a vehicle.

Electrical connectors may be damaged in other ways, such as because of contamination by dirt, water, moisture, or dust; improper use of the connector; large forces applied to the connector; or repeated use of the connector over time. When power connectors are damaged, equipment intended to be powered through the connector is often rendered inoperable. In applications, such as electric vehicle charging, damage to a power connector may have a significant impact, such as preventing a vehicle from being used. In applications such as energy storage, damage to a connector may prevent energy from being transferred either into or out of storage. Accordingly, quick and efficient repair of damaged connectors may be important.

Techniques as described herein may facilitate repairing electrical connectors without replacing a full electrical connector, avoiding repairs that might otherwise be expensive and time consuming. Techniques as described herein, for example, may enable a single terminal assembly of an electrical connector to be replaced, while leaving other terminal assemblies, a connector housing and other components of the connector. Alternatively, a damaged housing of a connector might be replaced with a new housing, reusing terminal assemblies, which may already be terminated to cables.

To support serviceability, an electrical connector may include modular components in combination with releasable engagement features that integrate these modular components into a connector system. The modular components may include individual components of the connector or assemblies of multiple components of the connectors. The modular components may be assembled to form the electrical connector or a portion of the electrical connector. The modular components may be removed from the connector and replaced with new components during servicing or repair of the connector. The inventors have appreciated that the use of modular components allows connectors to be repaired without requiring replacement of the connector, which allows connectors to be repaired faster and at lower cost, as all components of the connector are not required to be repaired or replaced.

In some examples, components of an electrical connector may be held within a housing of the electrical connector with one or more releasable retaining members. The retaining members may interact with the housing of the electrical connector to secure the components of the connector. For example, the retaining members may engage with the housing. Optionally, the retaining members may engage with the housing via a snap fit or other releasable connection. Optionally, the retaining members may include a compliant portion which engages with a feature of the housing. Optionally, the retaining members may engage with one or more holes in the housing. Optionally, the retaining members may be disengaged from the housing to facilitate removal of the components secured within the housing.

One or more techniques as described herein may be used in high current electrical connectors. In some examples, high current electrical connectors are configured to support at least 160 A of current, at least 200 A of current, at least 300 A, at least 350 A, at least 400 A, at least 500 A, at least 600 A, at least 700 A, at least 1000 A, 200-800 A, or 350-700 A of current.

Connectors as described herein may include power terminals. The receptacle connector may include power terminals configured to engage with corresponding power terminals of the plug connector and vice versa. Power terminals may be sized and shaped to support the transfer of high current. In some examples, an electrical connector may be capable of receiving multiple power terminals, some or all of which may be installed to provide a desired current carrying capacity of the connector.

In some examples, the contacts of the electrical terminals may be stamped contacts. Stamped contacts for high current electrical connectors provide advantages over conventional machined pin/socket terminals, as the stamped contacts may be produced at a lower cost than conventional terminals and allow for termination to a greater number of wire or cable sizes and quantities than conventional terminals.

Electrical connectors as described herein may have modular and removable components, which enables efficient assembly, repair and/or replacement of components of an electrical connection system. By providing components that may be engaged from the exterior of the housing, such as retaining members as described herein, components such as terminal assemblies may be easily installed or removed from electrical connection systems. This capability may facilitate efficient and rapid repair of a single damaged component or subset of components of electrical connection systems that have been damaged. For example, a single terminal may be removed from a connector and replaced with a new terminal. This capability reduces the costs of maintenance of the electrical connection system and allows for faster replacement of components.

In addition, providing modular components such as the terminal assemblies increases the efficiency for assembling and replacing components by reducing the work required to replace individual components.

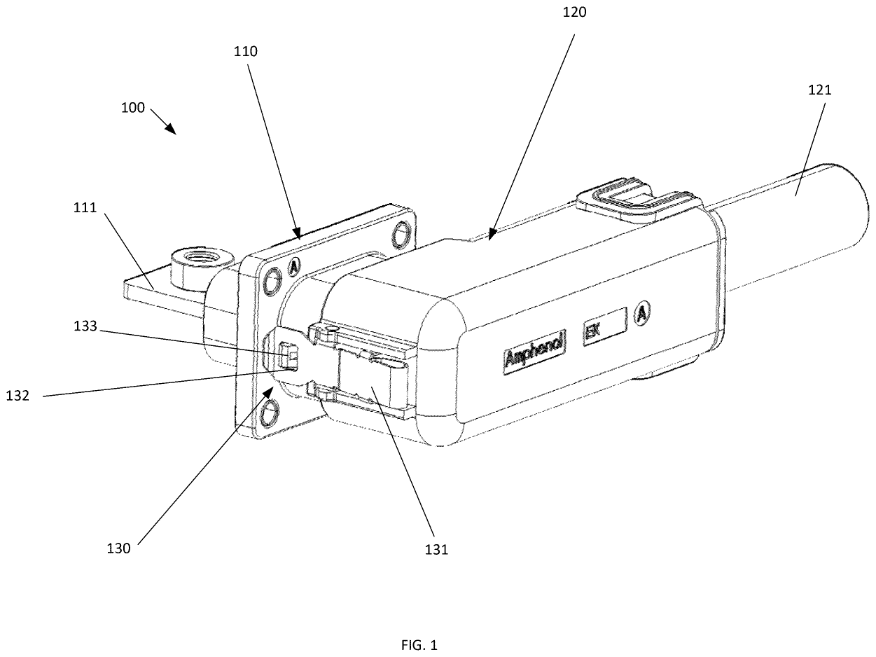

Techniques as described herein may be applied separately or in combination in any of multiple types of high current connectors, a subset of which are described herein as examples of these techniques. FIG. 1 is a perspective view of an example high current electrical connection system with mated receptacle and plug connectors, according to some embodiments of the technology described herein. The electrical connection system 100 includes receptacle connector 110 and plug connector 120. Receptacle connector 110 is configured to receive plug connector 120 during a mating process.

Receptacle connector 110 includes one or more conductors, of which conductor 111 is illustrated, which may be attached to cables or other electrical components for the transmission of electrical power. Plug connector 120 includes cable 121 which may connect to other electrical components for the transmission of electrical power. The connection system 100 in FIG. 1 may be used, for example, in a vehicle charging application. In that application, receptacle connector 110 may be mounted to a panel of a vehicle and conductors(s) 111 may be connected to the vehicle charging system (not shown). Plug connector 120 may be a part of a charging station, with cable 121 attached to a source of power.

Electrical connection system 100 may include features that facilitate operation. In the example illustrated, electrical connection system 100 includes latch mechanism 130. The latch mechanism 130 may secure plug connector 120 to receptacle connector 110. Latch mechanism 130 includes latch 131 attached to plug connector 120. Latch 131 may be made from a compliant material such as plastic or metal and includes hole 132, which engages with chamfered protrusion 133 of receptacle connector 110. While a chamfered protrusion is shown, other shaped protrusions may be used, such as protrusions with rounded edges.

The latch mechanism 130 may automatically engage during a connection process, simplifying making electrical connections.

Electrical connection system 100 may be configured such that latch mechanism 130 may be easily operated to disconnect plug connector 120 from receptacle connector 110. In this example, plug connector 120 is elongated along a first axis. Latch mechanism 130 is attached to plug connector 120 at an end wall perpendicular to that axis of elongation. In the example of FIG. 1, that end wall is opposite an end wall through which cable 121 enters plug 120. With this configuration, a user may easily grasp plug connector 120 around the elongated axis for connecting or disconnecting to receptacle connector 110. While grasping plug connector 120 in this way, latch mechanism 130 is not blocked by the user's hand, such that it may be readily unlatched, whether by the user's finger or a tool held by the user in a second hand.

The electrical connection system 100 may make one or more electrical connections between receptacle connector 110 and plug connector 120. Some or all these electrical connections may support a high current, as described herein. In some examples, an electrical connection may have a capacity to carry 350 A. Known metrics may be used to determine the current carrying capacity of a connection. Current carrying capacity, for example, may be determined based on the amount of current that results in a 30 degrees-C rise in temperature of the terminals relative to an ambient temperature. In the example, of FIG. 1, electrical connection system 100 has a single electrical connection.

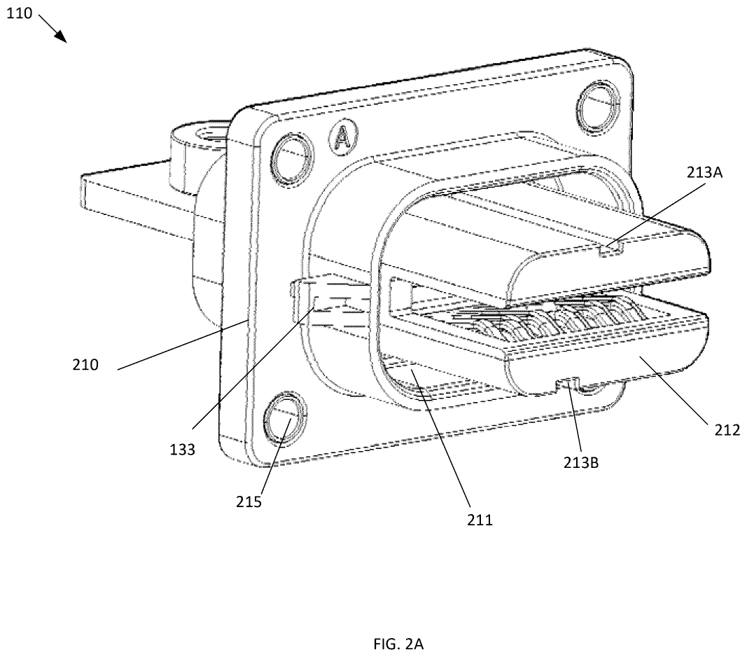

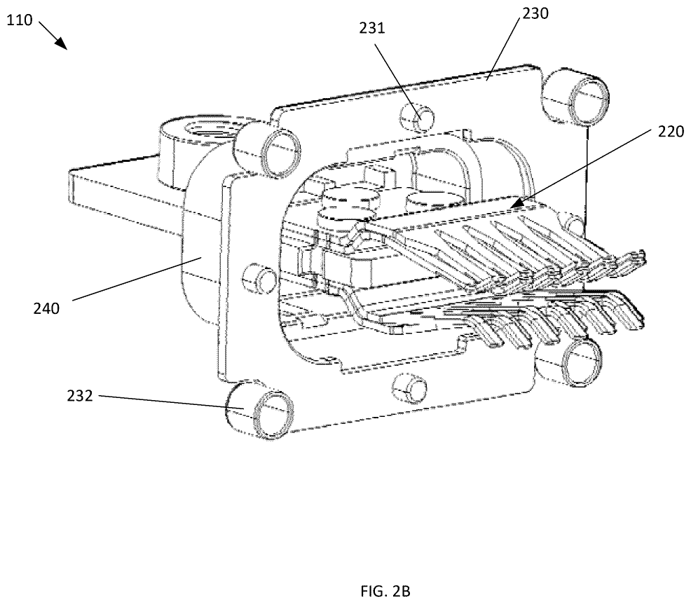

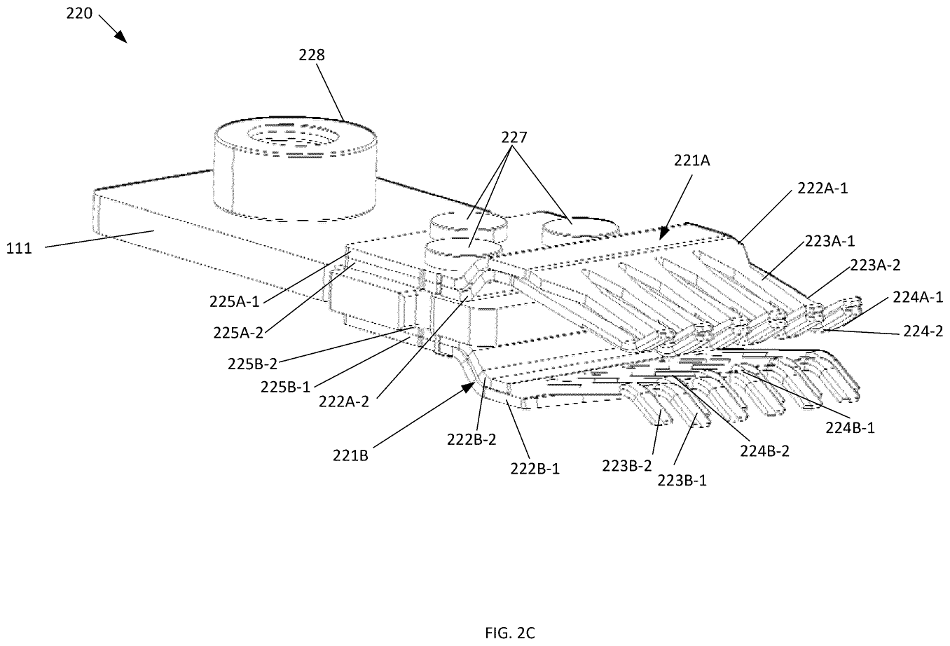

FIG. 2A is a front perspective view of the example receptacle connector of the high current electrical connection system of FIG. 1, showing the mating interface of the receptacle connector. Receptacle 110 includes front housing 210. Front housing 210 surrounds the internal components of the receptacle 110. The front housing may be made of an insulative material.

Front housing 210 includes receptacle cavity 211 for receiving a corresponding plug connector of the electrical connection system. Front housing 210 additionally includes mating interface 212 which surrounds the power terminal of the receptacle connector 200. Mating interface 212 includes channels 213A and 213B. Channels 213A and 213B interact with corresponding protrusions of the plug connector of the connection system. The channels 213A and 213B are configured such that the plug may be inserted into the receptacle in a proper orientation to complete the connection and may interfere with the plug if it is inserted in an improper configuration.

Chamfered protrusion 133 is provided on an exterior surface of a portion of receptacle front housing 210 bounding receptacle cavity 211. The chamfered protrusion is configured to interact with the latch of a latch mechanism, such as latch mechanism 130 of FIG. 1. The chamfered protrusion is angled with the chamfered surface opposing the insertion direction of the plug connector, such that during a mating process, latch 131 will ride along the chamfered protrusion and deflect outwards. As can be seen in FIG. 1, a distal end of latch 131 is also chamfered to facilitate this motion. When the latch 131 clears protrusion 133, it will return to its undeflected position with protrusion 133 extending into hole 132 such that latch 131 automatically engages protrusion 133.

Front housing 210 additionally includes holes 215 for securing the receptacle connector to a panel or other structure where electrical connection is desired. In some examples, fasteners may be inserted through holes 215 for securing the receptacle connector. In some examples, other securing techniques may be used for securing the receptacle connector 200.

FIG. 2B is a perspective view of the example receptacle connector of FIG. 2A with a front housing portion hidden. In this view, sealing plate 230 is visible. Sealing plate 230 may be mounted against a panel to which receptacle connector 110 is mounted and may aid in sealing the internal components of receptacle 110 from the exterior environment of the connection system. A sealing plate may be mounted to a back-side of the panel, opposite to the side on which the front housing 210 is mounted or may be between the front housing 210 and the panel. Sealing plate 230 includes alignment protrusions 231 which may engage with corresponding holes in the housing 210 for alignment of the sealing plate. Sealing plate 230 may be made of silicone, rubber or other compliant material that forms a seal when compressed by tightening fasteners holding front housing 210 against the panel (not shown).

Also shown are bushings 232 which may be inserted into holes 215 for use in securing the receptacle connector.

With front housing 210 hidden, a terminal subassembly inside the housing is visible. Receptacle connector 110 includes conductive terminal assembly 220. Terminal assembly 220 includes multiple fingers which engage with a terminal of the plug connector of the electrical connection system. Terminal assembly 220 may include a power terminal.

Also shown is retaining member 240 which may secure the terminal assembly 220 within front housing 210. Retaining member 240 may engage with front housing, such as by engaging snaps, latches or other connecting structures on front housing 210.

FIG. 2C is a perspective view of the terminal subassembly of the example receptacle connector of FIG. 2A. Terminal assembly 220 includes two conductor assemblies 221A and 221B. Conductor assemblies 221A and 221B may include the same components. As shown, conductor assemblies 221A and 221B are secured to opposite sides of conductor 111 with rivets 227, but other fastening techniques may be used, including screws, bolts or welding.

Conductor assembly 221A includes a first conductive sheet 222A-1 and a second conductive sheet 222A-2. Conductive sheets 222A-1 and 222A-2 include fingers 223A-1 and 223A-2, respectively. Fingers 223A-1 and 223-2 include contact portions 224A-1 and 224A-2, respectively. The contact portions contact the terminal of the plug when the plug connector is inserted into the receptacle 200. The conductive sheets are substantially planar with curved fingers. In some examples, the fingers may be planar. The contact portions are substantially coplanar in order to contact a planar terminal of the corresponding plug connector.

The fingers may be compliant to retain contact with the terminal of the plug connector when the plug is inserted into the receptacle 200. First conductive sheet 222A-1 and second conductive sheet 222A-2 may be formed of a material that is both conductive and compliant, which may be a different material than conductor 111. Conductor 111 may be made of a lower resistance copper alloy than the first conductive sheet 222A-1 and second conductive sheet 222A-2, for example.

The fingers 223A of conductor assembly 221A and the fingers 223B of conductor assembly 221B may be spread apart when the terminal of the plug connector is inserted into the receptacle connector. Rivets 227 secure the conductor assemblies 221A and 221B to the conductor 111 at mounting portion 225A-1, 225A-2, 225B-1 and 225B-2 of the first and second conductive sheets of the first and second conductor assemblies, respectively. In some examples, the conductive sheets may be stamped. Stamped conductive sheets may generally have a uniform thickness in one direction and extend generally in a plane perpendicular to the thickness direction, with portions bent in or out of the plane.

Conductor 111 may be configured for connection to another conductive component within an electrical system. The conductive component may be, for example, a bus bar or a terminal of a charging system in a vehicle, for example. In this example, nut 228 is connected to the conductor 111 for connection to other electrical components.

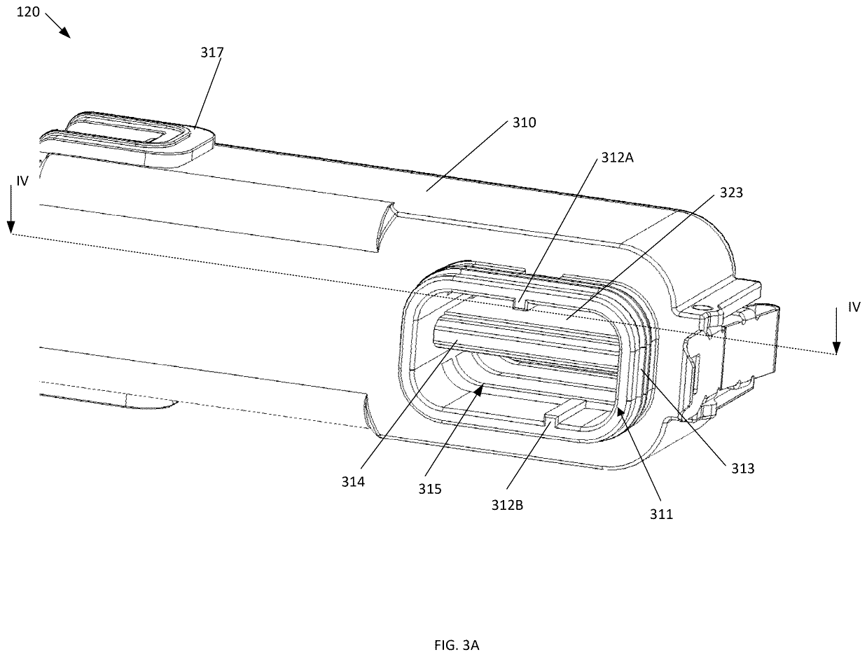

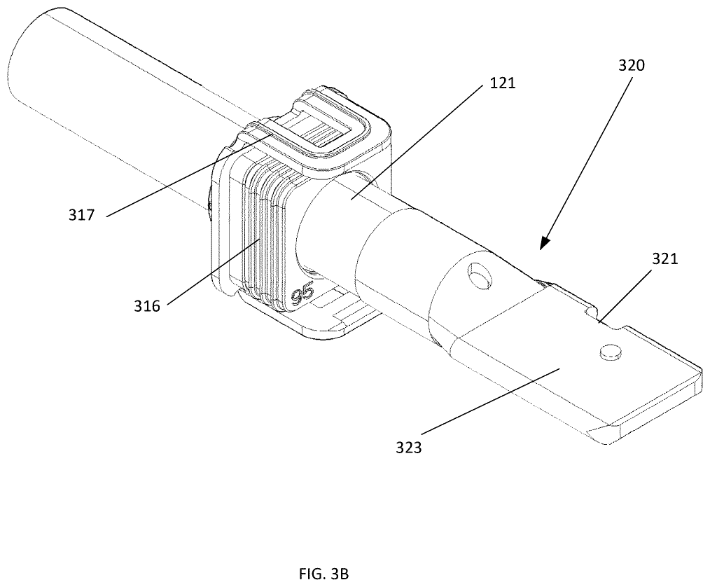

FIG. 3A is a front perspective view of the example plug connector 120 of the high current electrical connection system of FIG. 1 showing the mating interface of the plug connector. Shown in FIG. 3A is housing 310, which surrounds the internal components of the plug connector 120.

Housing 310 bounds mating interface 311. Mating interface 311 may be configured to be inserted into receptacle cavity, for example 211 of the receptacle 110. In some examples, the mating interface may interface with an electric vehicle or may interface with components of a power storage facility. The mating interface 311 includes protrusions 312A and 312B which may fit within channels 213A and 213B of the receptacle connector 200 of FIG. 2A to ensure a desired orientation of the plug 120 relative to receptacle 110.

Seal 313 may seal the interior of the connection system from the exterior environment, when the plug connector is inserted into the receptacle connector. Seal 313 may be positioned to be between the housing of plug 120 and the housing of receptacle 110 when plug 120 is mated to receptacle 110. In the example illustrated, seal 313 is around the exterior perimeter of mating interface 311. Optionally, seal 313 may be placed within a channel on a portion of the plug housing 310 bounding the mating interface 311. The seal 313 may be made of a flexible material, for example rubber or silicone, among other suitable materials.

Mating interface 311 also may include one or more terminals in a cavity 315 bounded by plug housing 310. In the example of FIG. 3A, mating interface 311 includes one terminal 323. Terminal 323 is located within the interior cavity 315 of the housing 310 of the plug 120. The terminal 323 may be configured to make contact with the contact portions of the fingers of receptacle 110. Terminal contact 323 may be a high current power terminal and may have a current rating that matches that of the terminals of receptacle 110.

Plug 120 optionally may include protective portion 314 within interior cavity 315. In the illustrated example, protective portion 314 may be formed as part of plug housing 310. Protective portion 314 may be insulative and may block objects, such as fingers of users or tools, from accidentally contacting the terminal 323. As shown, the protective portion has a curved surface which may assist in spreading the fingers of the terminal of the receptacle connector. The protective portion may block a portion of the opening of the mating interface 311.

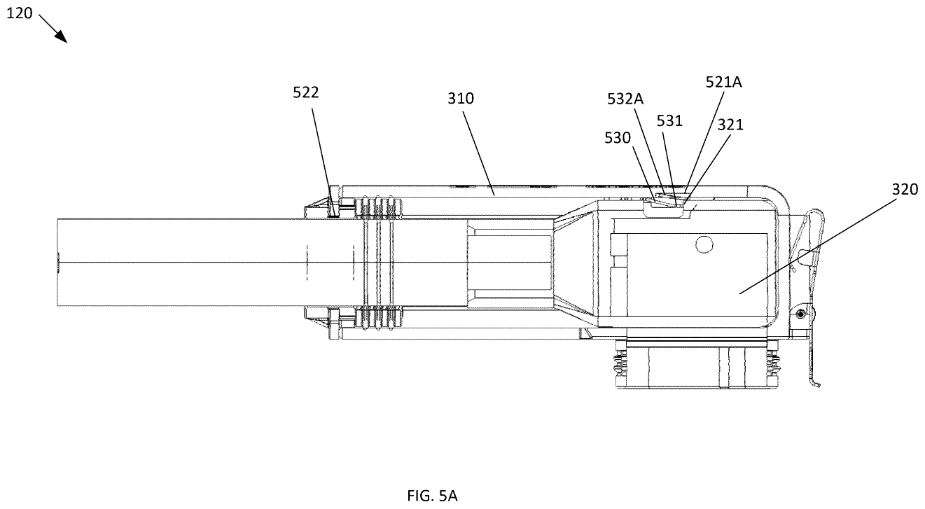

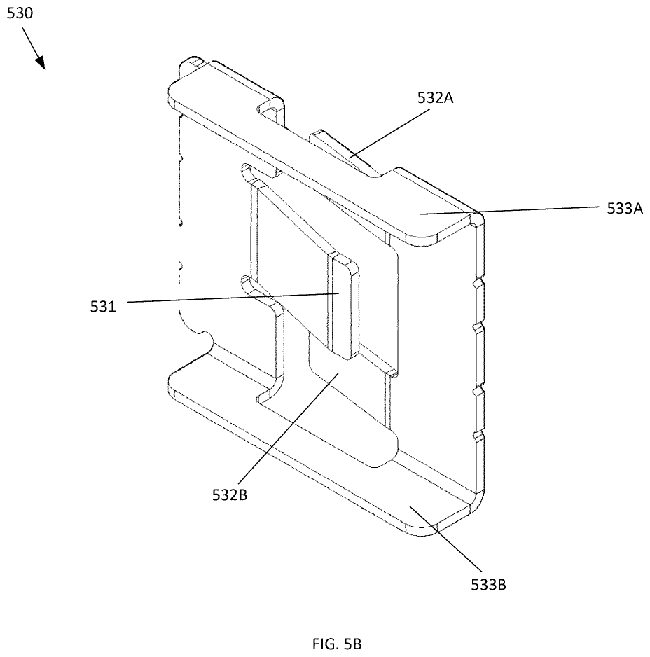

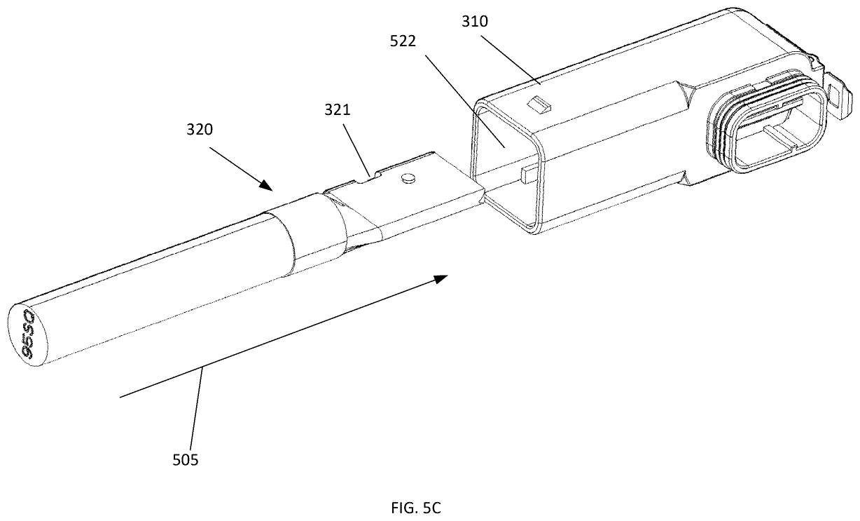

FIG. 3B is an example of internal components of the plug connector of FIG. 3A. Shown in FIG. 3B is terminal assembly 320. Terminal assembly 320 includes conductive terminal 323. The terminal assembly 320 may include one or more features that engage with features within the plug housing 310 to retain terminal assembly 320 in the housing. In this example, terminal 323 includes a positioning notch 321, which may interact with a retaining member in the housing 310, such as retaining member 530 (FIG. 5B). Cable 121 connects to terminal contact 323, such as by crimping or welding. In this example, terminal 323 is configured as a planar blade.

Plug 120 may include one or more components that seal the opening through which cable 121 enters housing 310. In the illustrated example, interior seal 316 is provided, which seals the interior cavity of the housing from the exterior environment. The interior seal 316 seals around cable 121—which passes through an opening in seal 316—and seals around the interior surface of the housing 310. The interior seal 316 may be made from a flexible material, for example rubber or silicone, among other suitable materials.

The interior seal 316 and other interior components of the plug connector 120 may be secured within the housing by clip 317. Clip 317 may engage with one or more features on the exterior surface of the housing to retain the interior components of the plug connector 120. Conversely, clip 317 may be disengaged from the housing to enable removal of the interior components. This capability may facilitate replacement of a damaged connector housing or damaged components within the housing. For example, the clip 317 may allow a user to quickly remove and/or replace the seal, cable, or terminal of the plug connector.

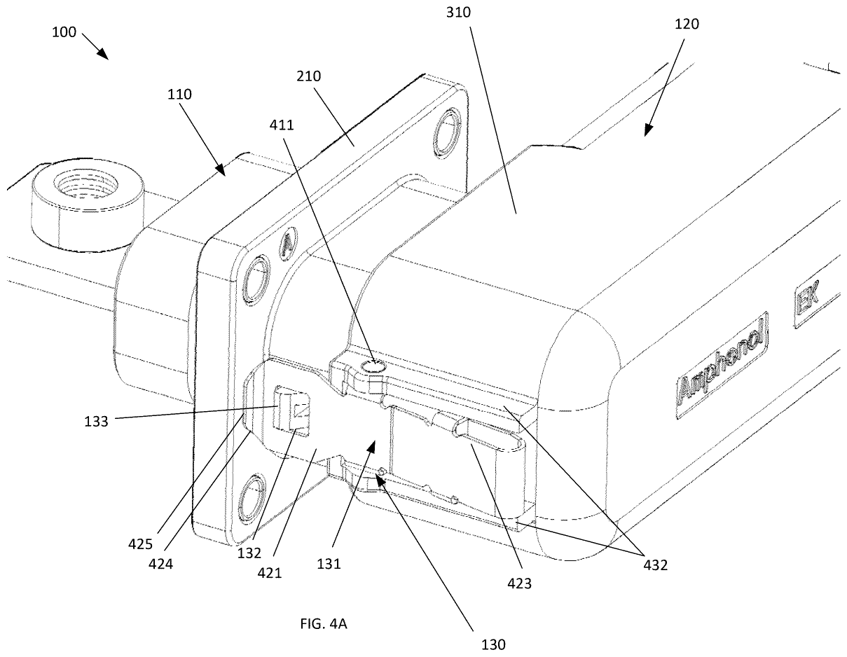

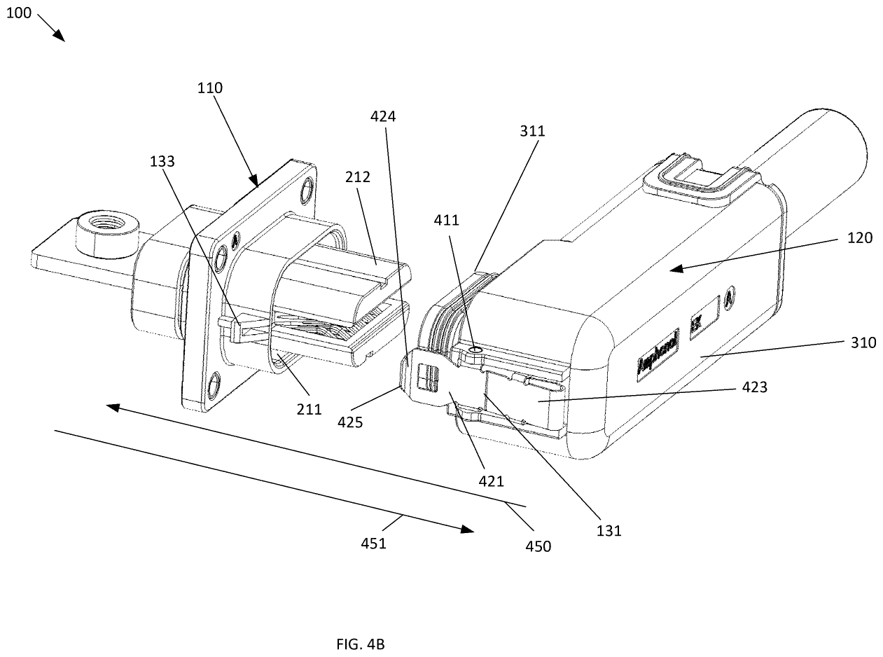

FIG. 4A is a view of a latch of the high current electrical connection system of FIG. 1 with mated receptacle and plug connectors. The electrical connection system 100 is an example of an electrical connection system in which a latching mechanism may be used. However, the latch mechanism 130 may be used in other electrical connection systems, including in other connector configurations as described herein.

The electrical connection system 100 includes latch mechanism 130. The latch mechanism includes latch 131. Latch 131 includes compliant portion 421 with hole 132. Compliance may be achieved by movably mounting latch 131 to plug housing 310. In the example illustrated, latch 131 is pivotably mounted to housing 410. Axle 411 pivotably mounts latch 131 to the housing. Axle 411 is attached to latch 131 and passes into protrusions 432 in the housing 310 of the plug connector 120. The openings in protrusions 432 may act as bearings for axle 411 such that axle 411 may rotate within the openings and pivot the distal end of latch 131 towards housing 310 for engaging protrusion 432 or away from housing 310 for releasing the latch from protrusion 432.

Latch 131 additionally includes folded portion 423 and projection 424. Folded portion 423 acts as a spring in this example. Folded portion 423 is compressed when the distal end of latch 131 pivots away from housing 310, which generates a spring force biasing the distal end of latch 131 towards housing 310. A spring force biasing the distal end of latch 131 towards housing 310 may alternatively or additionally be generated with springs of other shapes or as a result of flexing of latch 131, which in this example is elongated and may act as a compliant beam, if flexed. The spring force may provide for automatic latching when plug 120 is pressed onto receptacle 110. The configuration illustrated may also provide for easy unlatching, as a user grasping plug 120 may have a finger positioned to press on folded portion 423, which may pivot the distal end away from housing 310 to unlatch the plug from the receptacle.

FIG. 4B illustrates an example connection process of the high current electrical connection system of FIG. 1. The electrical connection system may be connected by moving the plug connector 120 along insertion direction 450. When the plug connector is moved in insertion direction 450, latch 131 may automatically engage with the chamfered protrusion 133 on the receptacle connector of the connection system. In the illustrated example, projection 424 at the end of the latch 131 is curved to facilitate latch 131 riding along chamfered protrusion, which in turn pivots the latch 131 about the axle 411 such that the compliant portion of the latch moves away from the housing 310 of plug connector 120.

When the hole 132 of the latch 131 is aligned with the chamfered protrusion, the complaint portion 421 of the latch may move towards the housing 310 of the plug 120 due to the spring force generated from moving the distal end of the compliant portion away from the housing 310. When the distal end of latch 131 moves toward the housing 310, the hole may engage with the chamfered protrusion, and the receptacle 110 and plug 120 portions may be secured together and connected.

Features of the receptacle connector including protrusion 212 and cavity 211 may work with mating interface 311 to guide the insertion of the plug connector 120 into the receptacle connector 110 during the connection process. When the receptacle 110 and plug 120 are connected, the terminal of the plug 120 may be inserted into and electrically connected to the terminal of the receptacle 110. The terminal of the plug 120 may contact the contact portions of the terminal of receptacle 110, forming a high current electrical connection.

The receptacle 110 and plug 120 may be unmated by moving the plug 120 in the removal direction 451. Before the receptacle 110 and plug 120 can be separated, the latch may be disengaged from the chamfered protrusion. The latch 131 may be disengaged by pivoting latch 131 around axle 411 to move the distal end 425 of latch 131 away from the housing 310 of the plug connector. A user of the electrical connection system 400 may move the latch 131 away from the housing 310 by pressing with a finger on latch 131 on the opposite side of axle 411 from projection 424, such as on the curved portion 423. Alternatively or additionally, a user may grasp projection 424 with a finger or a tool to move the distal end of latch 131 away from housing 310. Regardless of how latch 131 is disengaged from housing 310, once it is disengaged, the receptacle and plug 120 may be separated.

The latch mechanism provides an efficient way to secure the receptacle 110 and plug 430 of the connection system 400. The latch mechanism automatically engages when the plug 120 is properly inserted into the receptacle connector. The automatic engagement of the latch mechanism 130 allows a user to connect the receptacle and plug connectors with a single hand. The movement of the latch 131 may provide tactile feedback to the user that a proper connection has been made. The latch may be disengaged with a single finger and the plug 120 may then be removed from the receptacle 110 with a single hand.

Alternatively or additionally, high current connectors may be implemented with techniques that facilitate easy repair, often in the field and often without any special tools. In some examples, the connectors may include features that enable the terminals or terminal subassemblies to be removed from the connector housing such that the housing and/or the terminals may be replaced.

FIG. 5A is a cross section of a plug connector of the high current electrical connection system of FIG. 1. The view of FIG. 5A is taken along line IV-IV in FIG. 3A. The connector may include features that facilitate easy installation and/or removal of terminal assembly 320, including one or more features on the terminal subassembly that engage with one or more features within the housing.

In the illustrated example, terminal 323 includes positioning notch 321 which may be used to secure the terminal within the housing 310 of the plug connector 120. The retaining member inside the housing may be formed as part of the housing or may be an added component that is formed separately and engaged to the housing. In this example, retaining member 530 (FIG. 5B) is formed separately from the housing and may engage with the terminal assembly 320 and housing 310 to secure the terminal within the housing.

FIG. 5B is a perspective view of a retaining member of the high current electrical connection system of FIG. 1. Retaining member 530 includes compliant portion 531, which may engage with a terminal. Compliant portion 531 may fit into positioning notch 321 and press against the terminal, securing it in place within the housing 310. The terminal assembly may be secured against the housing 310. For example, the terminal assembly may be secured against a wall of the housing 310 by the retaining member. In some examples, the housing may include one or more features for securing the terminal assembly. For example, the internal cavity of the housing may include one or more channels, notches or similar features which the terminal assembly may be secured against. The one or more features may be included on the wall of the housing opposite the retaining member 531. The one or more features may be included on the wall of the housing opposite the opening 522. In some examples, the terminals assembly may be secured against protective portion 314, as discussed above with regard to FIG. 3A.

Retaining member 530 also includes first and second housing compliant portions 532A and 532B. Housing compliant portions 532A and 532B may engage with surfaces in the housing walls bounding an interior cavity of the housing to secure the retaining member in place within the housing of the plug connector. The first housing compliant portion 532A may fit within first opening 521A in housing 310, and may press against the housing bounding that opening to secure the retaining member 530 to the housing and allow the compliant portion 531 to press against terminal assembly 320. Retaining member 530 additionally includes end surfaces 533A and 533B which may be shaped to fit against corresponding surfaces of the housing of the plug connector.

In some examples, the retaining portion may be formed from stamped and folded sheet metal. In other examples, the retaining portion may be formed from a polymer material.

The compliant portion 531 of retaining member 530 may be depressed by a tool inserted through opening 522 in housing 310 to disengage it from positioning notch 321 and remove the terminal assembly 320 from the housing 310. A suitable tool may be long and thin, such as a screwdriver or similarly shaped tool, and may be readily available to a worker in the field maintaining an electrical connection system including plug 120.

In some examples, one or more components of the plug connector 120 must be removed before the opening 522 can be accessed. Opening 522 may be accessed, for example, by removing clip 317, which as described above, similarly may be done by a worker in the field. With clip 317 disconnected, seal 316 might also be removed if necessary to provide access through opening 522.

The terminal may be removed for repair or replacement of the terminal, housing or other components of the plug connector. When the compliant portion 531 is depressed, the terminal may be removed from the housing 310 through opening 522.

FIG. 5C illustrates an assembly process of a plug connector of the high current electrical connection system of claim 1. Though not shown in FIG. 5C, clip 317 and seal 316 may be threaded on cable 121, such as is illustrated in FIG. 3B, before the connector is assembled. Also not shown in FIG. 5C, before insertion of the terminal assembly, a retaining member may be positioned inside the housing. The retaining member may be positioned as described above, with reference to FIG. 5A. Terminal assembly 320 may be moved along insertion direction 505 though opening 522 in housing 310. The terminal assembly 320 includes a conductive terminal and a cable connected to the terminal. As the terminal assembly 320 is moved into the housing 310, the retaining member may be pressed into an opening in an upper wall of the housing such that the clip is secured within the housing. The terminal may contact the retaining member, and the compliant portion of the retaining member may engage with the positioning notch 321 in the terminal 323 when the terminal is properly positioned within the housing 310. In this way, the terminal may also be secured within the housing.

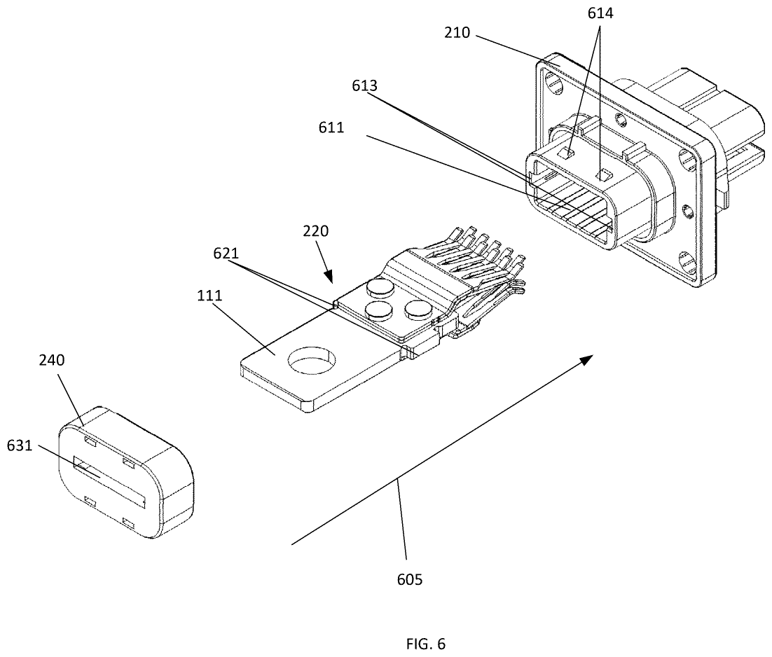

The receptacle connector may similarly support easy insertion and/or removal of a terminal assembly to facilitate repair of the housing, terminal or other components of the receptacle. A retaining member may similarly be used to hold a terminal assembly within the connector housing, and the retaining member may be internal or external to the connector housing. FIG. 6 illustrates an assembly process of a receptacle connector of the high current electrical connection system of FIG. 1. In this example, a retaining member, here shown as retaining member 240 is external to the housing. Shown in FIG. 6 is housing 210, terminal assembly 220 and retaining member 240. Terminal assembly 220 may be inserted into opening 611 in housing 210 in insertion direction 605. Retaining protrusions 621 in terminal assembly 220 may fit within channels 613 in opening 611. With retaining protrusions 621 in channels 613, rotation of the terminal assembly 220 within the housing is blocked. Further, in some embodiments channels 613 may have bottoms that interfere with retaining protrusions 621 when the terminal assembly is inserted to its desired position.

Retaining member 240 may then be moved over conductor 111 of the terminal assembly 220 and engage with snap-fit protrusions 614 in housing 210. In this way, the terminal subassembly may be captured between the bottom of channels 613 and retaining member 240, securing it in its desired position. While two snap-fit protrusions 614 are shown, housing 210 may include greater or fewer snap-fit protrusions, for example, one snap-fit protrusion, three snap-fit protrusions, four snap-fit protrusions, five snap-fit protrusions, six snap-fit protrusions or greater than six snap-fit protrusions. When engaged with snap-fit protrusions 614, the cap 240 is secured to the housing and the terminal is secured within the housing.

Retaining member 240 includes opening 631, which allows conductor 111 of the terminal assembly 220 to pass through, while covering channels 613 of the opening 611. When channels 613 are covered, the retaining protrusions 621 of the terminal assembly 220 prevent the terminal assembly 220 from being removed from the housing 210. In some examples, the retaining member may include protrusions which fit within the channels 613 to secure the terminal within the housing 210.

The retaining member may be removed from the housing by pulling the retaining member 240 in a direction opposite the insertion direction 605. The terminal assembly may then be removed from the housing for repair or replacement of the terminal or other components of the housing portion.

Having thus described several aspects of at least one embodiment of the technology described herein, it is to be appreciated that various alterations, modifications, and improvements will readily occur to those skilled in the art. For example, the number of power terminals in a connector may be increased and/or signal terminals may be included in a connector in addition to power terminals.

Such alterations, modifications, and improvements are intended to be part of this disclosure and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately” and “about” may be used to mean within ±20% of a target value in some embodiments, within ±10% of a target value in some embodiments, within ±5% of a target value in some embodiments, within ±2% of a target value in some embodiments. The terms “approximately” and “about” may include the target value.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

1. An electrical connector configured to support a high current, the electrical connector comprising:
an electrically conductive terminal, configured to support a current of at least 160A, comprising a mating portion and a cable termination portion, wherein the mating portion comprises an integral, generally planar metal member;
a cable terminated to the cable termination portion of the terminal;
an insulative housing comprising:
a cavity;
a first portion elongated in a first direction and comprising a first surface with a first opening into the cavity therethrough, the first opening sized for the electrically conductive terminal to pass through the first opening into the cavity;
a second portion comprising a second surface with a second opening into the cavity therethrough; and
at least one member elongated in the first direction spanning the second opening,
wherein:
the mating portion of the electrically conductive terminal is disposed within the cavity and accessible through the second opening;
the first surface and the second surface are at right angles; and
the cable terminated to the cable termination portion of the terminal extends through the first opening;
a cap secured to the housing so as to cover the first opening, and having the cable passing therethrough;
a metal clip, within the cavity, engaging a retaining notch of the electrically conductive terminal such that the electrically conductive terminal is retained within the cavity; and
a latch pivotably coupled to the second portion of the housing.

2. The connector of claim 1, wherein the latch is a compliant latch and is configured to automatically engage a protrusion on a second electrical connector when the electrical connector and second electrical connector are connected.

3. The connector of claim 2, wherein the latch comprises a curved projection and a hole configured to engage the protrusion of the second electrical connector.

4. The connector of claim 1, wherein the electrical connector is configured to connect to a second electrical connector in a direction perpendicular to the first direction.

5. The connector of claim 1, wherein the housing comprises one or more protrusions at the second opening configured to interact with respective channels of a second connector during a connection process.

6. The connector of claim 1, wherein the latch comprises a folded portion configured to contact the housing and provide a force to engage the latch with a protrusion of a second connector when the connector is connected to the second connector.

7. The connector of claim 1, further comprising a sealing portion at the second opening, configured to seal the cavity of the housing when the connector is connected to a second connector.

8. The connector of claim 1, further comprising a sealing portion at the first opening.

9. A method of manufacturing an electrical connector configured to support a current of at least 160A, the method comprising:
placing a clip within a cavity of an insulative housing;
moving a mating portion of an electrically conductive terminal in a first direction into a cavity of an insulative housing through a first opening in the housing, wherein the mating portion engages the insulative housing such that the clip is compressed between the electrically conductive terminal and the insulative housing; and
engaging the clip to the insulative housing and the electrically conductive terminal to the clip such that motion of the electrically conductive terminal in a direction opposite the first direction is restrained.

10. The method of claim 9, wherein:
the electrically conductive terminal comprises a cable termination portion and a cable is terminated to the cable termination portion;
the cable extends through the first opening; and
the method further comprises securing a cap to the housing to cover the first opening with the cable passing through the cap.

11. The method of claim 9, wherein:
the insulative housing comprises a second opening;
moving the mating portion of the electrically conductive terminal into the cavity of an insulative housing comprises positioning the mating portion within the second opening.

12. The method of claim 11, wherein:
the first opening is in a first surface of the insulative housing;
the second opening is in a second surface of the insulative housing; and
the first surface and second surface are orthogonal.

13. The method of claim 11, wherein:
the housing comprises a protective portion spanning the second opening; and
moving the mating portion of the electrically conductive terminal into the cavity of an insulative housing comprises aligning the mating portion with the protective portion.

14. The method of claim 13, further comprising:
attaching a latch at a pivot point on an exterior surface of the housing.

15. The method of claim 9, further comprising:
forming the terminal by stamping a sheet of metal.

16. An electrical connector system configured to support a current of at least 160A, the electrical connector system comprising:
a plug connector comprising:
a plug housing comprising a cavity;
a clip within the cavity; and
a plug terminal held within the cavity by the clip;
a receptacle connector comprising:
a receptacle housing comprising a cavity and an exterior surface with a plurality of protrusions on;
a receptacle terminal comprising a mating portion and a cable termination portion, wherein the mating portion comprises a plurality of spring fingers;
a retention member engaged to the exterior of the receptacle housing via a snap fit with the plurality of protrusions, the retention member comprising an opening with the cable termination portion of the receptacle terminal extending through the opening.

17. The electrical connector system of claim 16, wherein the clip is a metal member comprising a first compliant portion engaged to the plug housing and a second compliant portion engaged to the plug terminal.

18. The electrical connector system of claim 17, wherein the first compliant portion extends in a first direction and the second compliant portion extends in a second direction opposite the first direction.

19. The electrical connector system of claim 18, wherein:
the plug housing comprises a cavity and a first opening and a second opening into the cavity;
the plug terminal comprises a mating portion within the cavity and exposed through the second opening;
the clip is positioned within the cavity with the second compliant portion aligned with the first opening such that a tool inserted into the cavity moving in the second direction will deflect the second compliant portion to disengage the plug terminal from the clip.

20. The electrical connector system of claim 19, wherein:
the plug connector further comprises a seal and a clip removably holding the seal within the first opening.
